(19) United States
(12) Patent Application Publication
(10) Pub. No.: US 2020/0305363 A1
(43) Pub. Date: Oct. 1, 2020

(54) PREPARATION OF PLANT GROWTH SUBSTRATES FROM SUGAR CANE BAGASSE

(71) Applicants: Stefan Grass, Biel (CH); Jonas Lechot, Biel (CH)

(72) Inventors: Stefan Grass, Biel (CH); Jonas Lechot, Biel (CH)

(73) Assignee: Bagasse Solutions Inc., Naples, FL (US)

(21) Appl. No.: 16/366,124

(22) Filed: Mar. 27, 2019

(51) Int. Cl. A01G 24/27; C05C 11/00; C05C 5/00; A01C 23/04

(52) U.S. Cl. CPC A01G 24/27; A01C 23/042; C05C 5/00; C05C 11/00

(57) ABSTRACT

Processes for production of a plant growth substrate or a casing soil from sugar cane bagasse, and plant growth substrates produced from these processes are disclosed. The processes generally include biological removal of residual sugars, suppression of the development of cellulose degrading microorganisms so that the resulting mass loss is less than 10% of the original material dry weight, mechanical disintegration to form a disintegrated material with a defined density and porosity, reduction of pH and extraction of potassium to provide a defined electrical conductivity, and blending of the disintegrated material with one or more mineral components and plant nutrients. Additional steps in the process may include fermentation after the mechanical disintegration, and optionally addition of live organisms to add beneficial functions to the substrates. The substrate may find use as potting soil or blending components for soil mixes, or as casing soil for the production of mushroom.

### FIELD OF THE INVENTION

The present invention relates to plant growth substrates and processes for production of the plant growth substrate from sugar cane bagasse.

### BACKGROUND OF THE INVENTION

Sugar cane bagasse is the dry fibrous by-product of sugar production, constituting about 30 percent of the starting materials. Sugar cane bagasse contains a residual level of sugar and has a dry matter content between 35-55%. At present, this material is often burnt for the generation of heat and power. However, the heating value of this naturally moist material is limited and its handling requires additional operating cost for material feeding, equipment maintenance, and ash disposal, compared to the use of natural gas as a feedstock for energy production. A number of other uses of bagasse have been researched extensively, but have not become industrial practice. Such uses include the saccharification of the cellulosic fiber structure, e.g. for subsequent production of ethanol or organic acids, and utilization of the fibers for the substitution of synthetic fibers in the preparation of molds or extruded products. However, these developments have not become industrial practice.

Plant growth substrates are needed for production of seedlings, vegetables and ornamental plants in greenhouses, as well as the propagation of trees, grapes and similar plants in nurseries. They mostly and largely consist of peat, which offers several advantageous characteristics, such as strong resistance to biological degradation, a favorable porosity and capillarity, low nutrient content, low pH, and low electrical conductivity. However, peat is a fossil resource with limited availability and high environmental impact, including CO₂-emissions and destruction of moorland. A renewable substitute for peat would offer long-term security of supply and important environmental benefits.

The technical challenges of organic peat substitutes relate primarily to their resistance against microbial degradation. As all organic materials are eventually decomposed to carbon dioxide, water, and ash, peat is relatively resistant to such degradation, which makes it structurally stable, providing water and air pores over an extended period. Compost, on the other hand, is the result of a decomposition process; it is low in porosity, high in ash content and not suitable for substitution of peat. The decomposition process requires the presence of cellulose degrading bacteria, nitrogen, and air. Bacteria are generally quick in taking up available nitrogen, thereby immobilizing nitrogen and making it unavailable to plants. This effect can inhibit the growth of plants, in particular the growth of young plants with a limited root system. The challenge is to provide a peat substitute, which offers an intact fiber structure with a low level of nitrogen immobilization.

Prior art solutions to this technical challenge include the use of cellulosic plant materials that have been composted or treated to produce peat substitutes. As examples, U.S. Pat. Nos. 5,501,718 and 8,361,171 disclose processes that generally includes mixing cellulosic material with a bacterial inoculum and liquid manure. The result is a compost with the stated disadvantages, i.e., high density and salt content.

Other prior art solutions involve specifically the use of sugar cane bagasse. For example, in U.S. Pat. No. 3,163,517, sugar cane bagasse is compacted and weathered for more than 70 days, and dehydrated to reduce the moisture content to between 10 and 40 percent by weight through pressing and heating to temperatures of between 1300° F. and 1900° F. In U.S. Pat. No. 3,337,326, the bagasse is compressed into bales and weathered for at least 30 days to reduce the moisture content to less than 20 percent by weight, followed by addition of moisture and an additional weathering step of at least 30 days to reduce the moisture content to 30 to 60 percent by weight. Both processes require process time in excess of 60 days.

International Patent Application No. WO2012/066511 discloses a process that includes mixing plant parenchyma tissue with water, and composting the mixture to form a casing material. The plant parenchyma tissue is pith from sugar cane bagasse, coir and/or water hyacinth. The pith from sugar cane bagasse is defined as a residue from the bagasse-based paper production. The composting process is defined by a composting time in excess of 70 days.

Patent Application Publication No. US2007/0209273 discloses a growth medium comprising around 40% sugar cane mill mud and non-sphagnum peat and/or coconut fibre. Further disclosed are uses of the untreated sugar cane bagasse as a filler.

Prior art relating to the preparation of a peat substitutes also teaches the utilisation of wood and coconut fibres as raw materials. These materials are not composted, come closer to the specifications of peat, as compared to compost, and have proven their suitability in certain blends over a number of years. However, these materials have a distinctly different origin and composition, compared to sugar cane bagasse. Wood based substrates are lower in water holding capacity, porosity and capillarity, and can only be applied as a blending component of complex substrate mixes. As example, U.S. Pat. No. 5,413,618 discloses peat substitutes formed by high pressure and heat treatment of wood substrates, wherein the water holding capacity and capillarity are enhanced through addition of absorbent materials such as cellulose fibres, waste paper, cotton, or other materials.

None of these prior art solutions address the challenges in using sugar cane bagasse as a raw material, namely evident problems related to the structural stability and the nitrogen immobilisation. Accordingly, there is a need in the art for improved processing methods for preparation of structurally stable plant growth substrates with low density, high porosity, limited nitrogen immobilization, acceptable pH and suitability for application in simple blends with high ratio of this single component.

### SUMMARY OF THE INVENTION

The present invention provides processes for producing high-quality plant growth substrates from sugar cane bagasse.

Accordingly, disclosed herein is a process for production of a plant growth substrate from sugar cane bagasse, comprising biological removal of residual sugars while suppressing the development of cellulose degrading organisms, thereby limiting the biological activity in the material and the related nitrogen immobilization. The biological removal of residual sugars may be conducted by addition of a suspension of live organisms, is substantially completed within a period of 2-5 days, results in a limited mass loss of less than 10% by dry weight of the original raw material, and a nitrogen immobilization of less than 200 mg nitrogen per litre of material volume.

According to certain aspects of the process, the pH-level may be controlled or reduced to an optimal level of <7 by addition of a dilute mineral acid, an acidic salt, or a combination thereof. For reduction of the electrical conductivity, the conjugated base resulting from the mineral acid and/or acidic salt can be removed, together with other ions, such as, but not limited to potassium, using a mechanical extraction device.

According to certain aspects of the process, the suspension of selected strains of live organisms include Bacillus subtilis, Pseudomonas fluorescens, and/or other potentially beneficial organisms.

According to certain aspects of the process, a mechanical disintegration of the material is conducted so as to form a homogenous material with (i) a density less than 200 kg dry matter per m³, or less than 160 kg dry matter per m³, or even less than 130 kg dry matter per m³; (ii) a water absorption capacity of at least 2 litres of water per kg dry weight, or 3 litres of water per kg dry weight, or even 4 litres of water per kg dry weight; and/or (iii) a capillarity sufficient to draw a water level at minimum 2 cm above its filling level, or even 3 cm above its filling level.

According to certain aspects of the process, mineral components and/or plant nutrients may be added to the disintegrated material. An exemplary mineral component includes perlite, such as expanded perlite. The perlite may be treated with a plant stimulant, an inducer of plant resistance against phytopathogens, or a combination thereof. Exemplary plant nutrients include nitrogen, such as from controlled release nitrate.

The present invention also relates to plant growth substrates produced by any of the processes detailed herein. The plant growth substrate may have a pH-value of 5-7.5 and an electrical conductivity less than 1.8 mS/cm. For example, the plant growth substrate may have a pH-value of 5-7.5, such as 5-7, or 5.5-6.5, and an electrical conductivity of less than 1.3 mS/cm or even less than 1.0 mS/cm.

The present invention also relates to uses of the plant growth substrates disclosed herein, such as in application of the plant growth substrate in production systems applying fertigation, using a pre-calculated nutrient solution including nitrate as the primary nitrogen source; or in application of the plant growth substrate as a blending component for soil mixes; or in application of the plant growth substrate in potting soils and private gardening.

The present invention also relates to a casing soil comprising a plant growth substrate disclosed herein having a mineral component, an ash content of 10-50% of the total dry matter content, a pH of 7-8.3, and an electrical conductivity below 1.3 mS/cm. An exemplary mineral component includes calcium carbonate or bentonite.

### DETAILED DESCRIPTION OF THE INVENTION

As generally used herein, the articles “one”, “a”, “an” and “the” refer to “at least one” or “one or more”, unless otherwise indicated. For example, although reference is made herein to “a” sugar, “an” acid, and “the” substrate, one or more of any of these components and/or any other components described herein can be used.

The word “comprising” and forms of the word “comprising”, as used in this description and in the claims, does not limit the present invention to exclude any variants or additions. Additionally, although the present invention has been described in terms of “comprising”, the processes detailed herein may also be described as consisting essentially of or consisting of. For example, while the invention has been described in terms of a process comprising the steps of biological removal of residual sugars by fermentation, maintenance of the carbon to nitrogen level in excess of 80:1 and the water content to less than 50%, and adjustment of the pH-value to less than 7.0, a process consisting essentially of or consisting of the same steps is also within the present scope. In this context, “consisting essentially of” means that any additional steps or components in the process will not materially affect the plant growth material produced thereby.

The use of “or” means “and/or” unless specifically stated otherwise.

As used herein, the term “substantially” may be taken to represent the inherent degree of uncertainty that may be attributed to any quantitative comparison, value, measurement, or other representation. Thus, the term substantially may mean an amount of generally at least about 80%, about 90%, about 95%, about 98%, or even about 99%. If referring to a level of completion of a reaction, for example, the term “substantially” may be referenced to an amount of starting material remaining at completion of the reaction.

Other than in any operating examples, or where otherwise indicated, all numbers expressing, for example, quantities of ingredients used in the specification and claims are to be understood as being modified in all instances by the term “about”. Accordingly, unless indicated to the contrary, the numerical parameters set forth in the following specification and appended claims are approximations that may vary depending upon the substrate used and the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

“Including” and like terms means including, but not limited to. When ranges are given, any endpoints of those ranges and/or numbers within those ranges can be combined within the scope of the present invention.

In the following description, certain details are set forth in order to provide a better understanding of various embodiments of a process for production of a plant growth substrate from sugar cane bagasse. However, one skilled in the art will understand that these embodiments may be practiced without these details and/or in the absence of any details not described herein. In other instances, well-known structures, methods, and/or techniques associated with methods of practicing the various embodiments may not be shown or described in detail to avoid unnecessarily obscuring descriptions of other details of the various embodiments.

The present invention relates to plant growth substrates and casing soils, and processes for production of the same from sugar cane bagasse. The invention teaches a new understanding and control of the microbial activity in sugar cane bagasse useful to process the material into plant growth substrates and casing soils. It further teaches a method for control of the pH-value and the electrical conductivity value (EC-value), which are essential for high-quality plant growth substrates and casing soils. The invention further teaches several additional process improvements, which may result in the preparation of a new level of substrate quality, with the introduction of new functions for improved plant growth and plant health.

Fermentation and storage trials were set up and demonstrated that sugar cane bagasse is substantially more resistant to biological degradation as compared to other plant materials (i.e., integral plants including leaves and other components with higher nitrogen content). It was found to have a high carbon to nitrogen ratio above 80, and often above 100. These high ratios limit the development of microbes after the readily digestible components are consumed. This provides an excellent starting point for the development of a plant growth substrate. Based on these findings, the present inventors have defined specific process phases that aim to control the conditions for microbial development so that sugar cane bagasse may be transformed into a high quality plant growth substrate.

To that end, the present inventors provide herein several findings that enhance the understanding of the microbial activity in these starting materials. A bio-assay was conducted to determine the microbial activity in three distinct starting materials. The bio-assay was conducted in an incubator, at 30° C. and 100% relative humidity, and spraying 500 mg nitrogen in the form of an aqueous solution per liter of starting material. The present inventors have discovered that microbes develop more readily in plant parenchyma, which results in the consumption of 320 mg nitrogen per liter substrate within 20 days. In contrast, microbes grown on partially degraded fibers derived from the plant rind consume 210 mg nitrogen per liter substrate, and refined sugar cane bagasse consumes only 130 mg nitrogen per liter substrate, after bacterial consumption of the residual sugars contained therein. These findings support the conclusion that a composting process involving cellulose degrading microorganisms will rapidly continue to further degrade cellulose, once sufficient nitrogen is available, whereas substantially intact fibres with very limited biological degradation and related microbial capacity is more structurally stable and therefore much better suited as a peat substitute. Keeping the nitrogen immobilization of a substrate component at a low level, such as below 200 mg nitrogen per liter of substrate, is a key requirement for successful use of this component at an elevated ratio of the substrate.

The above trials also revealed that the pH-value and the EC-value of the starting material can go up during the course of the fermentation. These changes are generally and mostly related to the high potassium content of the material, which can be up to 3% of the dry matter content depending on the plant variety as well as the soil and storage conditions. Some of this potassium is present in the starting material in soluble form, and more can liberated during the fermentation, which may increases the pH and the EC to undesirable levels.

The electrical conductivity or EC-value as referred to in this document is expressed in millisiemens per centimeter mS/cm and is a proxy for the concentration of soluble ions in the material suspension. For the analysis, the material is diluted by 1.5 times its volume with demineralized water. The measurement value is based on the electrical resistance and distance between two electrodes, after creation of an electrical current in the suspension. Target values for plant growth substrates are generally less than 1.8 mS/cm, or less than 1.5 mS/cm, or less than 1.4 mS/cm, or less than 1.3 mS/cm, or less than 1.2 mS/cm, such as 1.0 mS/cm, depending on the level of fertilization and the type and growth stage of the plant.

The density of the material may be determined using the industrial norm EC 12580. According to certain aspects of the presently disclosed invention, the density of the material may be optimized by mechanical disintegration. Various methods of mechanical disintegration are known in the art and are useful in the presently disclosed invention, such as impact crushing. Optimal density levels include those less than 200 kg dry matter per m³, such as less than 160 kg dry matter per m³, or even less then 130 kg dry matter per m³.

Thus, the presently disclosed invention relates to a process for the production of a plant growth substrate that uses a sugar cane bagasse. The process includes biological removal of residual sugars from a starting material, such as by addition of a suspension of chosen microorganisms, and/or adjusting the dry matter content of the material to 30-45% (w/v), such as 40-45% (w/v). This level of dry matter content is generally sufficient to allow the consumption of the readily available fermentable components by microorganisms, e.g., residual sugars. The dry matter content can be adjusted by the addition of an aqueous solvent, such as water.

Dry matter refers to soluble and insoluble material, mostly fibers. The “dry matter content” is the ratio between the weight of the material when completely dried and the weight of the material with water. The dry matter content of a material is thus a measure of the amount of non-water or liquid components in the material.

Depending on the ambient temperature, this process of biological removal may be completed within about 5 days, such as about 4 days, or about 3 days, or even within about 2 days. The process of biological removal may be completed within about 2-5 days, such as within about 2-4 days, or about 2-3 days.

Further microbial activity is suppressed by a lack of nitrogen and phosphate, as well as the low water content. While micronutrients can be added at this point, they generally do not have an effect on the microbial development. As such, these conditions are very suitable for product storage and transport, such as open bulk material, in large bags or containers, or in closed commercial bags.

According to certain aspects, perlite may be added to the blend, thereby improving certain specifications of the blend, such as biological stability during storage and water absorption as well as desorption during plant growth.

This product may be supplied to professional growers with dedicated systems for plant irrigation and fertilization. Nitrogen, phosphate, and other nutrients may be added to the nutrient solution, as required by specific plant species and growth stages, according to the procedure set forth by the grower. Exemplary plant nutrients include nitrogen, phosphorous, magnesium, calcium, sulfur, and micronutrients known in the art, among others.

In an exemplary plant growth substrate formed using the inventive methods disclosed herein, the substrate blend may be simple and may only require the addition of perlite, and nutrients. The ratio of perlite may be 5-50%, preferably 10-30% by volume. This largely reduces the complexity and cost of substrate blending, compared to blends with wood fibres.

Microbial development may restart after addition of nutrients and water, such as by the grower. However, the number of cellulose degrading microbes is very low at this point, resulting in slow microbial development and plenty of available nutrients for the plant roots.

According to certain aspects, the consumption of the readily digestible components may be further supported or enhanced by the addition of bacteria. The preferred bacterial strains include those selected from the species Bacillus subtilis, Pseudomonas fluorescens, or selected from other potentially beneficial organisms. Propagation of these bacteria may suppress the development of soil borne pathogens in the substrate, which poses serious challenges in plant propagation and production systems.

According to certain aspects of the presently disclosed invention, additional nitrogen fertilizer may be added in the form of controlled release nitrate. Use of the controlled release nitrogen may limit or control the development of microbial activity during plant growth.

According to certain aspects of the presently disclosed invention, the electrical conductivity, pH-level, and/or the potassium content of the material may be controlled or reduced, such as at the beginning of the process. Such control may be necessary, depending on the type of the raw material, as well as its production and storage conditions. This control may be conducted by spaying a dilute mineral acid, e.g. sulfuric acid, or an acidic salt, e.g. iron sulfate, onto the material and subsequently extracting a press juice from the material, using a screw press. This process step results in the extraction of 30-50% of the total potassium, and reduces the EC- and pH-values at the same time. For example, the application of 1.5 g sulfuric acid in dilute form per kg dry matter and subsequent dewatering to a dry matter content of 38% resulted in a pH of 5.9 and an electrical conductivity of 1.0 mS/cm. Both the EC- and pH-values have proved to be relatively stable over time.

Another element of the invention relates to the fineness of the fiber structure, which determines the pore size, the ratio of water to air pores, and the capillarity of the material. This fineness can be adjusted by the degree of mechanical treatment, i.e., mechanical disintegration. Finer fibers will provide more water pores and improved capillarity. The mechanical disintegration may be conducted using an impact mill in fully continuous operation, and controlling residence time and specific energy input of the machine (kWh per kg throughput).

The mechanical disintegration may form a disintegrated material having a density of less than 200 kg dry matter per m³, such as less than 160 kg dry matter per m³, or even less than 130 kg dry matter per m³. The mechanical disintegration may form a disintegrated material having a water absorption capacity of at least 2 litres of water per kg dry weight, such as at least 3 litres of water per kg dry weight, or even at least 4 litres of water per kg dry weight. The mechanical disintegration may form a disintegrated material having a capillarity sufficient to draw a water level at minimum 2 cm above its filling level, or even at minimum 3 cm above its filling level.

For example, using 300 ml nursery containers filled with 33 g dry weight potting soil prepared according to the inventive procedures disclosed herein, a water uptake and retention of 134 g was measured (i.e., 4 litres of water per kg dry weight). Putting the same containers on an ebb and flow table, it was observed that the substrate was able to draw the water by capillary action to a level 3 cm above the water level of the table.

Thus, as disclosed, an exemplary embodiment of the present invention may include providing sugar cane bagasse as a starting material; biological removal of residual sugars in the starting material while suppressing development of cellulose degrading microorganisms, thereby reducing the nitrogen immobilization to a level below 200 mg nitrogen per liter of starting material within 20 days of incubation; reducing the pH-level to 7.0 or below by addition of a dilute mineral acid, and acidic salt, or a combination thereof; and maintenance of a carbon to nitrogen ratio of at least 80:1, and a water content of less than 50% by weight, thereby preventing development of cellulose degrading organisms and limiting microbial degradation to a maximum weight loss of 8% dry weight of the starting material.

According to any of the embodiments disclosed herein, the process may optionally further include addition of live organisms to enhance the biological removal of readily digestible components and add favourable functions to the end product. The live organisms may be selected from strains of Bacillus subtilis, Pseudomonas fluorescens, and/or other potentially beneficial organisms.

According to any of the embodiments disclosed herein, the process may optionally include reducing the electrical conductivity using an extraction device, such as a screw press. The extraction device may remove conjugated base(s) resulting from the mineral acid and/or acidic salt. The electrical conductivity may be less than 1.8 mS/cm, or less than 1.3 mS/cm, or even less than 1.0 mS/cm.

According to any of the embodiments disclosed herein, the process may include mechanical disintegration of the starting material to form a disintegrated material, and blending of the disintegrated material with one or more mineral components and/or plant nutrients. The biological removal and mechanical disintegration steps can be conducted in either order. Moreover, the mechanical disintegration step may form a disintegrated material having one or more of a density of less than 130 kg dry matter per m³, a porosity sufficient to absorb at least 2 litres, 3 litres, 4 litres, or more of water per kg dry weight of the disintegrated material, and a capillarity sufficient to draw a water level at minimum 1 cm, or 2 cm, or even 3 cm or more above its filling level.

The process may optionally further include mineral components blended with the disintegrated material, comprising expanded perlite. The perlite may be treated with a plant stimulant, an inducer of plant resistance against phytopathogens, or a combination thereof. The process may optionally further include plant nutrients blended with the disintegrated material such as nitrogen, or controlled release nitrate.

The present invention also relates to plant growth substrates produced by any of the processes detailed herein. The plant growth substrate may have a pH-value of 5-7.5 and an EC-value of less than 1.8 mS/cm. For example, the plant growth substrate may have a pH-value of 5-7.5, such as 5.5-6.5, and an EC-value of less than 1.0 mS/cm when excess potassium is extracted from the disintegrated material. This product supports initial nitrogen availability to the plants and optimum plant growth. It may be supplied to private and professional growers, for potting soil, tree nurseries, and other. Nitrogen, phosphate and other nutrients may be added at a later stage as required by specific plant species and growth stages. Microbial development will restart after the addition water, such as when used on the grower's or hobby gardeners site. However, the degradation of cellulose, as well as the loss of substrate mass, occurs very slowly, comparable to peat.

The plant growth substrate may include additional mineral constituents as discussed hereinabove, such as expanded perlite. According to certain aspects, the perlite may be added to the substrate blend, such as at a ratio of 10-30% by volume. It has been observed that the addition and mechanical blending of the perlite resulted in further mechanical refining of the plant growth substrate. Part of the perlite can be treated with a plant stimulant and/or an inducer of plant resistance against phytopathogens/fungal diseases.

Moreover, the plant growth substrates may be used directly in planting applications, or mixed with additional components to provide a substrate or growth medium.

The present invention also relates to uses of the plant growth substrates disclosed herein, such as in application of the plant growth substrate in production systems applying fertigation, using a pre-calculated nutrient solution including nitrate as the primary nitrogen source; or in application of the plant growth substrate as a blending component for soil mixes; or in application of the plant growth substrate in potting soils and private gardening.

Growth trials using basil and, tomatoes, cucumbers, poinsettia and other plants have resulted in excellent plant growth, comparable to standard commercial products containing 70% peat.

Trials using fermented material according to an embodiment of the invention disclosed above were tested for use as casing soil in the production of mushrooms. For this application, mineral components were added, such as ash, to achieve a mineral content (e.g., an ash content) of around 35% of the total dry weight and the pH was adjusted to around 8.0. “Ash content” refers to the residues of a specified combustion procedure and can include calcium carbonate, bentonite, and minerals. The tests applied industry standard production parameters, and allowed comparison with standard peat based casing soil in a scientific trial set up. Surprisingly, a blend of 50% of this material with 50% white peat produced the same mushroom yield and quality as the standard casing soil with 100% black peat. Low EC-values and microbial activity, as well as correct pH-values and high water holding capacity were found to be key success factors of the newly developed casing material.

Thus, according to aspects of the presently disclosed invention, the processes disclosed herein may be used to provide a casing soil comprising a plant growth substrate as disclosed herein having a mineral component, an ash content to 10-50% of the total dry matter content, a pH of 7.5-8.3, and an electrical conductivity below 1.3 mS/cm. An exemplary mineral component includes at least calcium carbonate and/or bentonite.

It is to be understood, that the product applications named here serve as examples and are not limited and do not exclude other applications.

All documents cited herein are incorporated herein by reference, but only to the extent that the incorporated material does not conflict with existing definitions, statements, or other documents set forth herein. To the extent that any meaning or definition of a term in this document conflicts with any meaning or definition of the same term in a document incorporated by reference, the meaning or definition assigned to that term in this document shall govern. The citation of any document is not to be construed as an admission that it is prior art with respect to the systems and methods described herein.

The following aspects are disclosed in this application:

Aspect 1: A process for production of a plant growth substrate from sugar cane bagasse, the process comprising biological removal of residual sugar and suppression of the development of cellulose degrading microorganisms by means of nitrogen depletion and insufficient availability of water; wherein a ratio of carbon to nitrogen is >80 and a water content is less than 50% by weight.

Aspect 2: The process according to aspect 1, wherein the nitrogen immobilization is <200 mg per litre substrate.

Aspect 3: The process according to aspect 1, further comprising a mechanical disintegration step to form a homogenous porous disintegrated material, wherein the biological removal and mechanical disintegration steps can be conducted in either order.

Aspect 4: The process according to aspect 3, wherein the disintegrated material comprises one or more of (i) a density less than 200 kg dry matter per m³, or less than 160 kg dry matter per m³, such as less than 130 kg dry matter per m³, (ii) a water absorption capacity of at least 2 litres, or at least 3 litres, or even at least 4 litres of water per kg dry weight, and (iii) a capillarity sufficient to draw a water level at minimum 2 cm, or 3 cm above its filling level.

Aspect 5: The process according to aspect 3 or 4, further comprising blending the disintegrated material with one or more mineral components and plant nutrients.

Aspect 6: The process according to aspect 5, wherein the mineral components to be blended with the disintegrated material comprise expanded perlite.

Aspect 7: The process according to aspect 6, wherein the perlite is treated with a plant stimulant, an inducer of plant resistance against phytopathogens, or a combination thereof.

Aspect 8: The process according to aspects 6 or 7, wherein the expanded perlite is blended with the disintegrated material at a blending ratio of 1-50%, preferably 10-30%.

Aspect 9: The process according to any one of aspects 1 to 8, further comprising control or reduction of the pH to less than 7.0, such as less than 6.5, such as less than 6.0, and reduction of the electrical conductivity to less than 1.8 mS/cm, such as less than 1.3 mS/cm, or even less than 1.0 mS/cm.

Aspect 10: The process according to aspect 9, wherein reduction of the pH comprises using a liquid extraction device and a dilute mineral acid, an acidic salt, or a combination thereof.

Aspect 11: The process according to aspect 9 or 10, wherein the electrical conductivity is controlled or reduced by extraction of excess potassium and/or a conjugated base of the mineral acid or acidic salt used for pH correction.

Aspects 12: The process according to aspect 11, wherein extraction of excess potassium may be completed before or after the biological removal and/or the mechanical disintegration.

Aspect 13: The process according to any one of aspects 1 to 12, wherein the biological removal of residual sugars is completed in a time period of 2 to 5 days, such as 2 to 4 days, or even 2 to 3 days, and results in a mass loss of less than 10% by dry weight, such as less than 6% by dry weight.

Aspect 14: The process according to any one of aspects 1 to 13, adding live organisms to enhance the biological removal of residual sugar.

Aspect 15: The process according to aspect 14, wherein the live organisms are selected from strains of Bacillus subtilis, Pseudomonas fluorescens, or other potentially beneficial organisms.

Aspect 16: The process according to any one of aspects 1 to 15, wherein the biological removal of residual sugars is conducted after the mechanical disintegration

Aspect 17: The process according to any one of aspects 1 to 16, wherein nitrogen is added in the form of controlled released nitrate.

Aspect 18: A plant growth substrate produced by the process according to any one of aspects 1 to 17.

Aspect 19: The plant growth substrate according to aspect 18, generating a nitrogen immobilization of less than 200 mg nitrogen per liter substrate

Aspect 20: The plant growth substrate according to aspect 18 or 19, having a pH-value of 5-7.5, such as 5-7, or 5.5-6.5.

Aspect 21: The plant growth substrate according to any one of aspects 18 to 20, having an EC-value <1.8 mS/cm, or <1.3 mS/cm, or <1.0 mS/cm.

Aspect 22: Application of the plant growth substrate according to any one of aspects 18 to 21.

Aspect 23: The application according to aspect 22, (i) in production systems applying fertigation, using a pre-calculated nutrient solution including nitrate as the primary nitrogen source, or (ii) as a blending component for soil mixes, or (iii) in potting soils and private gardening.

Aspect 24: A casing soil comprising a plant growth substrate produced by the process according to any one of aspects 1 to 17.

Aspect 25: The casing soil according to aspect 24, further comprising a mineral component, an ash content of 10-50% of the total dry matter content, a pH of 7-8.3, and an electrical conductivity <1.3 mS/cm.

Aspect 26: The casing soil according to aspects 24 or 25, wherein the mineral component comprises calcium carbonate, bentonite, or a combination thereof

What is claimed is:

1. A process for production of a plant growth media from sugar cane bagasse, the process comprising:
addition of a suspension of live organisms to a starting material of sugar cane bagasse, wherein the live organisms remove residual sugars on the starting material by fermentation;
maintenance of a carbon to nitrogen ratio of at least 80:1, and a water content of less than 50% by weight, thereby preventing development of cellulose degrading organisms and limiting microbial degradation to a maximum weight loss of 8% dry weight of the starting material; and
adjustment of a pH-value to less than 7.0 by addition of a dilute mineral acid, an acidic salt, or a combination thereof,
wherein activity of the live organisms is limited to a nitrogen immobilization of <200 mg nitrogen per liter of starting material within 20 days of incubation.

2. The process of claim 1, additionally comprising
mechanical disintegration of the starting material to form a disintegrated material with a density less than 200 kg dry matter per m³, a water absorption capacity of at least 3 litres of water per kg dry weight, and a capillarity sufficient to draw a water level at minimum 3 cm above its filling level.

3. The process of claim 1, additionally comprising
mechanical disintegration of the starting material to form a disintegrated material with a density less than 130 kg dry matter per m³, a water absorption capacity of at least 4 litres of water per kg dry weight, and a capillarity sufficient to draw a water level at minimum 3 cm above its filling level.

4. The process of claim 1, wherein the removal of residual sugar is substantially completed in a time period of 2 to 5 days.

5. The process of claim 1, wherein the live organisms are selected from strains of Bacillus subtilis, Pseudomonas fluorescens, or a combination thereof.

6. The process of claim 1, wherein a conjugated base resulting from the mineral acid and/or acidic salt added to adjust the pH-value is removed using an extraction device, thereby reducing the electrical conductivity of the material.

7. The process of claim 6, wherein the electrical conductivity is reduced to less than 1.8 mS/cm.

8. The process of claim 2, additionally comprising:
addition of one or more of a mineral component and a plant nutrient to the disintegrated material to form a blend having a dry matter content of at least 50%.

9. The process of claim 8, wherein the mineral component comprises perlite.

10. The process of claim 9, wherein the perlite is treated with a plant stimulant, an inducer of plant resistance against phytopathogens, or a combination thereof.

11. The process of claim 8, wherein the plant nutrient is nitrogen.

12. The process of claim 11, wherein the nitrogen is controlled release nitrogen.

13. The process of claim 1, further comprising:
addition of nutrients for preparation of a fertilized plant growth media.

14. A plant growth substrate formed by the process of claim 1, having a pH value of 5.5-6.5 and a conductivity value of less than 1.8 mS/cm.

15. Application of the plant growth substrate according to claim 14 as a blending component for soil mixes.

16. Application of the plant growth substrate according to claim 14 in production systems applying fertigation, using a pre-calculated nutrient solution including nitrate as a primary nitrogen source.

17. A process for production of a plant growth media from sugar cane bagasse, the process comprising:
biological removal of residual sugars from a starting material of sugar cane bagasse by fermentation;
mechanical disintegration of the starting material to form a disintegrated material with a density less than 200 kg dry matter per m³, a water absorption capacity of at least 3 litres of water per kg dry weight, and a capillarity sufficient to draw a water level at minimum 3 cm above its filling level;
maintenance of a carbon to nitrogen ratio of at least 80:1, and a water content of less than 50% by weight, thereby preventing development of cellulose degrading organisms and limiting microbial degradation to a maximum weight loss of 8% dry weight of the starting material; and
adjustment of a pH-value to less than 7.0 by addition of a dilute mineral acid, an acidic salt, or a combination thereof,
wherein the biological removal and the mechanical disintegration are performed in either order, and
wherein the process provides a nitrogen immobilization of <200 mg nitrogen per liter of starting material within 20 days of incubation.

18. The process of claim 17, additionally comprising:
addition of a suspension of live organisms to the starting material, wherein the live organisms enhance removal of residual sugars on the starting material, wherein the removal of residual sugar is substantially completed in a time period of 2 to 5 days.

19. The process of claim 17, wherein the live organisms are selected from strains of Bacillus subtilis, Pseudomonas fluorescens, or a combination thereof.

20. A plant growth substrate formed by the process of claim 17, having a pH value of 5.5-6.5 and a conductivity value of less than 1.8 mS/cm.

21. A casing soil comprising: a plant growth substrate produced by the process according to claim 1; a mineral component; and an ash content of 10-50% of the total dry matter content, wherein the casing soil has a pH of 7-8.3 and an electrical conductivity <1.3 mS/cm.
